(19) United States
(12) Patent Application Publication
(10) Pub. No.: US 2011/0233928 A1
(43) Pub. Date: Sep. 29, 2011

(54) ROTATABLE FLANGE APPARATUS AND METHOD

(76) Inventor: Jason Lars Olsen, Wellesley, MA (US)

(21) Appl. No.: 12/749,020

(22) Filed: Mar. 29, 2010

(51) Int. Cl. F16L 23/00

(52) U.S. Cl. 285/406

(57) ABSTRACT

A rotatable flange structure is provided which can be installed over the front-mating surface of a plumbing and heating apparatus. A retaining ring fits inside the grooves on the outer edge of a flange portion and on the inner edge of a mounting plate to keep the mounting plate attached to the flange portion. The flange portion can be easily assembled to the rotatable mounting plate and can be removed from the rotatable mounting plate in only one direction. The retaining ring is compressed slightly by the flange portion as the rotatable mounting plate is installed to the flange portion over its front side and snaps back out into the mounting plate groove to complete the assembly and retain the mounting plate to the flange portion.

### BACKGROUND

The present invention relates generally to flanges and more particularly to flanges for connecting plumbing and heating components.

Flanges are well known structures used to provide mating surfaces on plumbing and heating components for interconnection there-between. Typical flanges include surfaces which fit against similar mating surfaces on other components to provide a fluid seal in the connection. Flanges also typically include mounting portions that provide for fasteners such as holes for accepting studs or bolts which are used to securely connect the flange to a mating flange or mating surface.

Typical plumbing and heating components such as pipes and valves are provided with a flange that is fixedly formed with portions of the component body or main structure. For example, a typical heating system valve may include a flange portion that is monolithically formed with the valve body. Such fixedly formed flange portions can make mounting in certain orientations or positions difficult or impossible due to interferences with other fixedly mounted apparatus and structures.

Simple collar type mounting structures are not suitable to provide a rotatable flange in most plumbing and heating components because any such collar structure generally needs to be mounted from the back side of the plumbing or heating component. Collars that are large enough to be installed to a plumbing or heating component from the front side, e.g. over the mating surface, can not be used to retain an interconnection between mating surfaces because they would not provide the necessary overlap with the mating surface to retain it. Such simple collars can not be used for mounting components that include structural elements which interfere with installation of a collar from the back side. Accordingly, partial collars or keyed collars with a partial overlapping surface have been used to provide a rotatable mounting structure around a flange if they are to be installed from the front, i.e., mating surface side, of a component. However such partial collars, two piece bifurcated collars and slotted collars are problematic, for example, because they may not provide mounting integrity in all orientations, they may easily fall off an associated plumbing or heating component during shipping or handling, and they may be difficult to hold in place during mounting of the component.

### SUMMARY OF THE INVENTION

Illustrative embodiments of the present invention provide a rotatable flange that can be installed over the front-mating surface of a plumbing or heating component, that provide mounting integrity through 360 degrees of rotation, and that can not fall off the component over the front surface after installation.

The rotatable flange apparatus includes a flange portion, a rotatable mounting plate and a retaining ring. The retaining ring fits inside grooves on the outer edge of the flange portion and on the inner edge of the mounting plate to keep the mounting plate attached to the flange portion. The flange portion can be easily assembled to the rotatable mounting plate and can be removed from the rotatable mounting plate in only one direction. The retaining ring is compressed slightly by the flange portion as the rotatable mounting plate is installed to the flange portion over its front side and snaps back out into the mounting plate groove to complete the assembly and retain the mounting plate to the flange portion.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a perspective view of a rotatable flange apparatus according to an illustrative embodiment of the invention;

FIG. 2 is a cross section view of a flange portion of a rotatable flange apparatus according to an illustrative embodiment of the invention;

FIGS. 3A and 3B are a cross sectional view and a top view of a retaining ring according to an illustrative embodiment of the invention;

FIG. 4 is a cross section view of a rotating ring according to an illustrative embodiment of the invention; and

FIG. 5 is a cross section view of an assembled rotatable flange apparatus according to an illustrative embodiment of the invention.

### DETAILED DESCRIPTION

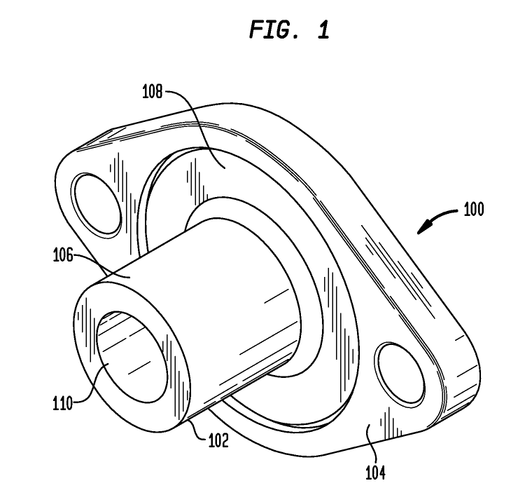

A rotatable flange apparatus according to an illustrative embodiment of the invention is described with reference to the perspective view shown in FIG. 1. The rotatable flange apparatus 100 includes a flange portion 102, a rotatable mounting plate 104 and a retaining ring (not shown). The flange portion 102 includes a neck portion 106, a face portion 108 extending from the flange portion and a path such as a fluid flow path 110 extending through the neck portion 106 and the face portion 108.

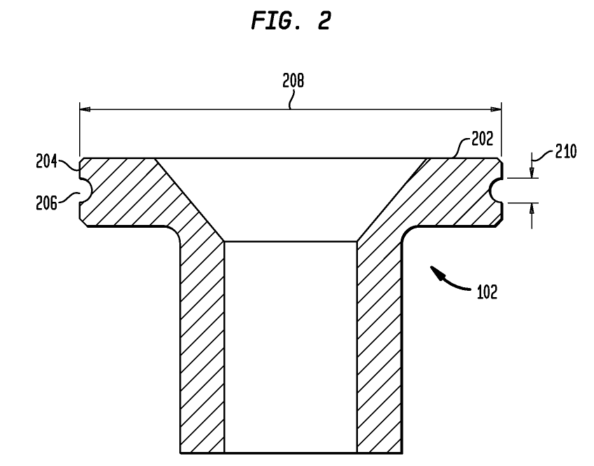

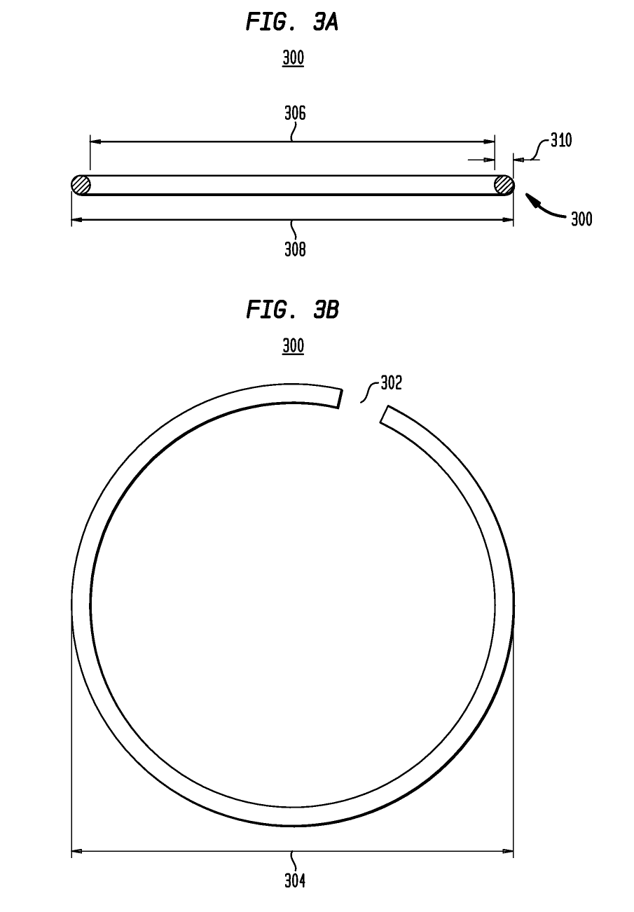

A cross sectional view of the flange portion according to an illustrative embodiment of the invention is described with reference to FIG. 2. The flange portion 102 includes a sealing surface 202, an outside edge 204 and a ring groove 206 in the outside edge 204. A retaining ring 300, as shown in FIGS. 3A and 3B is configured to be disposed in the ring groove 206. Illustratively, the ring groove 206 has a semi-circular cross sectional shape and a cross sectional diameter 210 corresponding to a cross sectional diameter 310 (FIG. 3) of the retaining ring 300 (FIG. 3) to provide a slip fit between the retaining ring 300 (FIG. 3) and the ring groove 206.

In the illustrative embodiment of FIG. 3, the retaining ring 300 is formed from a spring material and includes a ring gap 302. The ring gap 302 allows deformation of the retaining ring 300 in opposition to a spring force of the retaining ring 300. The retaining ring 300 can be deformed to a compressed outside dimension 304 of the retaining ring. In an illustrative embodiment, the retaining ring 300 deformation may include extension to an extended inside dimension of the retaining ring 300 for installation to the groove 206 (FIG. 2).

In the illustrative embodiment, the retaining ring has an inside diameter 306 less than a diameter 208 of the face portion 200. In the illustrative embodiment, the retaining ring has an outside diameter 308 greater than the diameter 208 of the face portion 200.

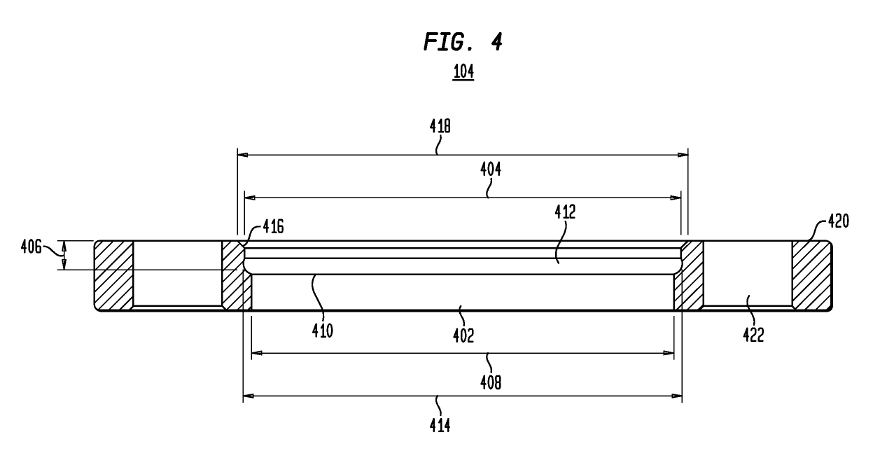

The rotatable mounting plate 104 in the illustrative embodiment is illustrated in a cross sectional view in FIG. 4. The mounting plate 104 includes a hole 402 for accepting and retaining the face portion 108 (FIG. 1) of the flange portion 102 (FIG. 1). The hole 402 has a first diameter 404 greater than the compressed outside dimension 304 (FIG. 3B) of the retaining ring 300 (FIGS. 3A, 3B) to a first depth 406, and a second diameter less than said ring outside diameter beyond said first depth to form a stop 410 at the first depth 406.

The stop 410 prevents the face portion 108 (FIG. 1) from passing through the hole 402 when the retaining ring 300 (FIGS. 3A, 3B) is installed in the ring groove 206 (FIG. 2). In the illustrative embodiment, the stop 410 allows the face portion 108 (FIG. 1) to pass through the hole 402 when the retaining ring 300 (FIGS. 3A, 3B) is not installed in the ring groove 206 (FIG. 2). Illustratively, the stop 410 can be formed as a first annular groove 412 in the hole 402 at the first depth 406 in which the first annular groove 412 has a diameter 414 greater than the first diameter 404 of the hole 402.

Illustratively, the hole 402 can have a lead-in chamfer 416 extending on a front surface of the mounting plate 104 to the first diameter 404 of the hole. The chamfer 416 illustratively has a diameter 418 at the front surface 420 greater than the outside diameter 308 (FIG. 3A) of the retaining ring 300 (FIG. 3A, 3B)

In the illustrative embodiment, the rotatable mounting plate 104 includes at least one fastener hole 422 extending there-through. A rotatable mounting plate 104 according to an illustrative embodiment may alternatively or additionally include at least one fastener stud or other fastener element extending therefrom (not shown) for mating with a corresponding mounting fastener in a plumbing interface, for example.

The flange portion may be assembled with or monolithically formed with other plumbing components. For example, in an illustrative embodiment, at least one valve body (not shown) is in communication with the neck portion and monolithically formed with the neck portion. The valve body may include portions preventing the rotatable mounting plate from fitting over the valve body, thereby requiring assembly of the rotatable mounting plate over the face portion.

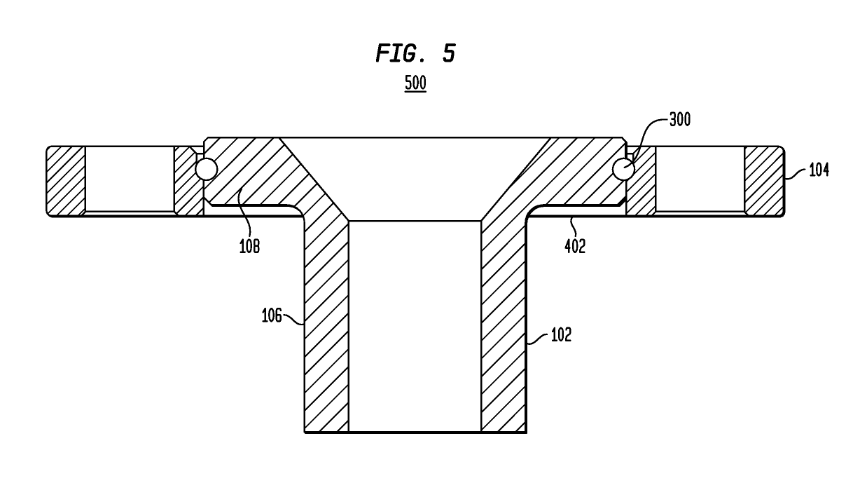

In illustrative embodiments of the invention, the retaining ring 300 (FIGS. 3A, 3B) fits inside the grooves 206 (FIG. 2) and 412 (FIG. 4) to keep the mounting plate 104 (FIG. 1) attached to the flange portion 102. Referring to FIG. 5, the flange portion 102 can be easily assembled to the rotatable mounting plate 104 and can be removed from the rotatable mounting plate 104 in only one direction. The retaining ring 300 is compressed slightly by the flange portion 104 as the flange portion 102 is installed to the rotatable mounting plate 104 and snaps back out into the first annular groove 412 (FIG. 4) to complete the assembly.

A method for forming a plumbing interface with a rotatable flange according to an illustrative embodiment of the invention is described with reference to FIG. 5 which includes a cross sectional view of an assembled flange assembly 500 The method includes installing a rotatable mounting plate 104 over a flange portion 102. The rotatable mounting plate 104 has a hole 402 to accept the flange portion. The rotatable mounting plate 104 also includes at least one interference portion, such as retaining ring 300 preventing the flange portion 102 from passing completely through the hole 402. The illustrative method may also include the step of installing the interference portion between said flange portion 102 and the rotatable mounting plate 104 before installing the rotatable mounting plate 104 over said flange portion 102.

The illustrative method for forming a plumbing interface according to the present invention may also include the steps of aligning mounting elements, such as holes and or studs, for example, in the mounting plate with corresponding mounting elements in a plumbing interface and rotating the flange portion to a selected orientation. A face of the flange portion is then located against a mating face of the plumbing interface. Fasteners are installed to the mounting elements to secure the mounting plate to the plumbing interface so that the mounting plate retains the flange portion against the plumbing interface.

Although the various embodiments of the invention are described herein in terms of a plumbing interface, it should be understood by persons having ordinary skill in the art that the present invention includes virtually any type of fluid system interface, such as heating system interfaces, cooling system interfaces, exhaust system interfaces, gas transfer interfaces and the like.

Further, it should be appreciated that although the flange portion embodiments described herein are described as including a fluid flow path, the flange portion could be used as an interconnect wherein the path is not for fluid flow but instead is a passage such as for wire, cable conduct or the like.

While the invention has been described and illustrated in connection with preferred embodiments, many variations and modifications will be evident to those skilled in the art and may be made without departing from the spirit and scope of the invention. The invention is thus not to be limited to the precise details of methodology or construction set forth above as such variations and modification are intended to be included within the scope of the invention.

What is claimed is:

1. A rotatable flange apparatus, comprising:
a flange portion including a neck portion, a face portion extending from the flange portion and a fluid flow path extending through the neck portion and the face portion;
said face portion including a sealing surface, an outside edge and a ring groove in said outside edge;
a retaining ring disposable in said ring groove, said retaining ring being formed from a spring material and including a ring gap allowing deformation of said ring in opposition to a spring force of said retaining ring,
said deformation including compression to a compressed outside dimension of said retaining ring;
said retaining ring having an inside diameter less than a diameter of said face portion and having an outside diameter greater than said diameter of said face portion;
a rotatable mounting plate including a hole for accepting and retaining said face portion;
said hole having a first diameter greater than said compressed outside dimension to a first depth and a second diameter less than said ring outside diameter beyond said first depth to form a stop at said first depth, said stop preventing said face portion from passing through said hole when said ring is installed in said ring groove and allowing said face portion to pass through said hole when said ring is not installed in said ring groove.

2. The apparatus of claim 1, wherein:
said stop comprises a first annular groove in said hole at said first depth, said first annular groove having a diameter greater than said first diameter.

3. The apparatus of claim 1, wherein:
said ring groove has a semi-circular cross sectional shape and a cross sectional diameter corresponding to a cross sectional diameter of said retaining ring and providing a slip fit between said retaining ring and said ring groove.

4. The apparatus of claim 1, comprising:
said hole having a lead-in chamfer from a front surface of said rotatable mounting plate to said first diameter, said chamfer having a diameter at said front surface greater than said outside diameter of said retaining ring.

5. The apparatus of claim 1, comprising:
said rotatable mounting plate including at least one fastener hole extending there-through.

6. The apparatus of claim 1, comprising:
said rotatable mounting plate including at least one fastener stud extending there-from.

7. The apparatus of claim 1, comprising:
said deformation including extension to an extended inside dimension of said retaining ring for installation to said groove.

8. The apparatus of claim 1, comprising:
at least one valve body in communication with said neck portion and monolithically formed with said neck portion.

9. The apparatus of claim 8, wherein said valve body includes portions preventing said rotatable mounting plate from fitting over said valve body and thereby requiring assembly of said rotatable mounting plate over said face portion.

10. A method for forming a plumbing interface with a rotatable flange, comprising:
installing a rotatable mounting plate over a flange portion, the rotatable mounting plate having a hole to accept said flange portion and at least one interference portion preventing the flange portion from passing completely through said hole.

11. The method of claim 10, comprising:
installing said interference portion between said flange portion and said rotatable mounting plate before installing said rotatable mounting plate over said flange portion.

12. The method of claim 10, comprising:
aligning mounting elements in said mounting plate with corresponding mounting elements in a plumbing interface;
rotating said flange portion to a selected orientation;
locating a face of said flange portion against a mating face of said plumbing interface;
installing fasteners to said mounting elements to secure said mounting plate to said plumbing interface so that said mounting plate retains said flange portion against said plumbing interface.

13. A rotatable flange apparatus, comprising:
a flange portion including a neck portion, a face portion extending from the flange portion and a flow path extending through the neck portion and the face portion;
said face portion including a sealing surface, an outside edge and a retaining groove in said outside edge;
a retaining element disposable in said ring groove, said retaining element being formed from a spring material and including a gap allowing deformation of said retaining element in opposition to a spring force of said retaining element,
said deformation including compression to a compressed outside dimension of said retaining element;
said retaining element having an inside dimension less than a dimension of said face portion and having an outside dimension greater than said dimension of said face portion;
a rotatable mounting plate including a hole for accepting and retaining said face portion;
said hole having a first diameter greater than said compressed outside dimension to a first depth and a second diameter less than said ring outside diameter beyond said first depth to form a stop at said first depth, said stop preventing said face portion from passing through said hole when said ring is installed in said ring groove and allowing said face portion to pass through said hole when said ring is not installed in said ring groove.
